(19) United States
(12) Patent Application Publication
(10) Pub. No.: US 2019/0076910 A1
(43) Pub. Date: Mar. 14, 2019

(54) Method for Manufacturing a Rim

(71) Applicant: METAL INDUSTRIES RESEARCH & DEVELOPMENT CENTRE, Kaohsiung City (TW)

(72) Inventors: Kai-Min Tang, Kaohsiung City (TW); Chun-Hao Tseng, Kaohsiung City (TW); Bing-Chuen Hu, Kaohsiung City (TW)

(21) Appl. No.: 15/836,959

(22) Filed: Dec. 11, 2017

(30) Foreign Application Priority Data
Sep. 14, 2017 (TW) 106131614

(51) Int. Cl. B21D 53/30; C21D 9/34; B21D 22/02; B23K 9/16

(52) U.S. Cl. CPC B21D 53/30; C21D 9/34; F27D 2009/0089; B23K 9/16; C21D 2211/008; B21D 22/02

(57) ABSTRACT

A method for manufacturing a rim is provided to overcome the problem that the strength of the rim as manufactured by the conventional manufacturing method reduces due to the annealing of the welding operation. The method includes processing a first material with a cold stamping process to form a disc embryo, with the first material being made of steel; processing a second material with a cold rolling process to form a rim embryo, with the second material being made of steel; coupling the disc embryo and the rim embryo with each other by a welding approach to form a semi-processed rim; and processing the semi-processed rim with a hot stamping process to form the rim.

### CROSS REFERENCE TO RELATED APPLICATION

The application claims the benefit of Taiwan application serial No. 106131614, filed on Sep. 14, 2017, and the contents of which are incorporated herein by reference.

### BACKGROUND OF THE INVENTION

### 1. Field of the Invention

The present invention generally relates to a method for manufacturing a rim and, more particularly, to a method for manufacturing a lightweight and high-strength rim.

### 2. Description of the Related Art

In light of the limited resources of the earth and the reduction in energy waste, it has been a goal to increase the energy-saving efficiencies of various devices in addition to reducing the use of devices with high energy consumption. As an example of automobile industry, it has been a goal to reduce the fuel consumption by reducing the weights of the automobiles. The weight of an automobile includes sprung weight and unsprung weight. Sprung weight refers to the weights supported by the suspension including the weights of the body of the car, the engine, the transmission and the passengers. Unsprung weight refers to the weights of the rims, the tires, the propeller shaft and the shock absorber. Since the amount of the fuel saved from the reduction in unsprung weight of 1 kg is substantially equal to the amount of the fuel saved from the reduction in sprung weight of 10 kg or even 15 kg, it is necessary to reduce the weight of the rims.

Since the rims require motive power from the transmission engine and need to bear the vibration and impact from the ground, the rims should have a proper strength. Therefore, the weight of the rims cannot be reduced without taking the strength into consideration. The common material of rims in the market is usually aluminum alloy or steel. Aluminum alloy can be used to manufacture rims by casting or forging process. The aluminum rim manufactured by casting process has a smaller weight than the conventional steel rim. However, the production of the larger-size rims under the casting process often leads to product defect in the manufacturing process, leading to a high defect rate. Although the strength of the rim manufactured under the forging process can be significantly increased to be larger than that of the aluminum rim manufactured under the casting process while having a weight significantly smaller than the steel rim, the price is also much higher.

In light of this, the conventional steel rims are advantageous in term of price. In the current manufacturing process of the steel rim, the disc portion and the rim portion of the steel rim are independently formed under the cold stamping process and then are welded together. However, the cold stamping process does not heat and soften the steel material so that the strength of the steel material itself will affect the strength of the steel rim after assembly. Besides, the steel material will rebound after the cold stamping process due to the release of residual stress. Thus, several rounds of cold stamping processes are required to achieve the precise property (8-10 rounds for the disc portion and 6-8 rounds for the rim portion). Besides, since the use of high strength steel material in the cold stamping processes in attempt to increasing the strength would instead result in difficult processing of the steel material due to the excessively high strength thereof, the strength of the steel rim used in the cold stamping processes is also limited. As a result, the weight cannot be reduced due to the maintenance in the strength of the steel rim. Therefore, the weight of the steel rim cannot be reduced due to the maintenance in the strength.

Currently, some manufacturers have been trying to reduce the weight of the steel rim by increasing the strength of the steel material and reducing the thickness thereof by ways of, for example, forming the disc portion first by the hot stamping process. In this manner, the disc portion manufactured by the hot stamping process has a tensile strength up to about 1500 MPa while the rim portion manufactured by the cold stamping process has a tensile strength of about 440 MPa. The difference in the strength being about 3 times therebetween. Thus, the thickness of the material can be significantly reduced. However, when the two parts are welded, the heat affected zones will be annealed, leading to the reduction in the strength of the steel rim in the heat affected zones. Furthermore, under different strengths of the disc portion and the rim portion, it is not easy to control the welding parameters nor does it ensure that the properties meet the required standards of the steel rim after welding.

In light of this, it is necessary to improve the conventional method for manufacturing the rims.

### SUMMARY OF THE INVENTION

It is therefore the objective of this invention to provide a method for manufacturing a lightweight and high-strength rim.

A method for manufacturing a rim is disclosed. The method includes processing a first material with a cold stamping process to form a disc embryo, with the first material being made of steel; processing a second material with a cold rolling process to form a rim embryo, with the second material being made of steel; coupling the disc embryo and the rim embryo with each other by a welding approach to form a semi-processed rim; and processing the semi-processed rim with a hot stamping process to form the rim.

Based on this, in the method for manufacturing a rim according to the invention, the steel material will have a higher strength after the hot stamping process. In the same time, the heat affected zones are heated and quenched. Thus, the heat affected zones are not annealed, such that the strength after the hot stamping processes is not adversely affected by the softening of the heat affected zones. Therefore, under the same weight, the rim according to the invention has a higher strength compared with the other rims. On the contrary, under the same strength, the rim according to the invention can have a smaller thickness compared with the other rims. As a result, the weight of the rim can be reduced, reducing the fuel consumption.

In an example, processing the semi-processed rim includes sending the semi-processed rim to a heating furnace having a temperature of 1050-1280° C. for heating and stamping operations. Thus, the steel material can be softened to precisely shape the semi-processed rim, or to further adjust the thickness of the rim to meet the required size. Accordingly, a rim is formed as a finished product, increasing the shaping precision of the rim.

In an example, the first and second materials may be high-strength alloy steel. Thus, the first and second materials can have rust resistance and acid resistance while possessing excellent rigidity, improving the durability of the rim.

In the above, since it is not required to cope with the metal rebounding of the rim embryo that occurs in the case of cold rolling process, it takes only 5-7 rounds of processing, reducing the processing time and cost.

In the above, since it is not required to cope with the metal rebounding of the rim embryo that occurs in the case of cold rolling process, it takes only 4-6 rounds of cold rolling processes, reducing the processing time and cost.

In an example, the welding approach is gas-shielded arc welding. Thus, the rim as a finished product has a better welding quality.

In an example, the welding approach is full welding. Thus, the welded parts can be coupled more securely, improving the welding reliability.

In an example, processing the semi-processed rim includes a quenching process. Thus, the rim can have a uniform Martensite crystal structure, improving the strength of the rim.

In an example, processing the first material includes forming a plurality of decorative holes on the disc embryo. The decorative holes can enhance the circulation of the air, improving the cooling effect of the rim and providing an aesthetic effect.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

It is another objective of the invention to provide a method for manufacturing a rim where the welded parts of the rim are not annealed.

FIG. 1 shows a flowchart of a method for manufacturing a rim according to a preferred embodiment of the invention.

FIG. 2 is an exploded, perspective view of a rim according to the preferred embodiment of the invention.

FIG. 3 is a cross sectional view of the rim after assembly according to the preferred embodiment of the invention.

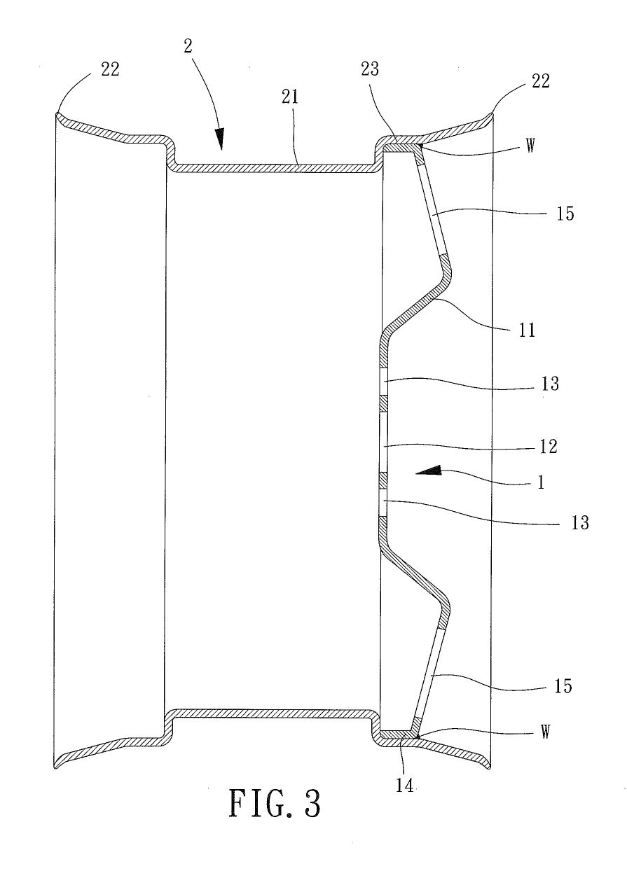

In the various figures of the drawings, the same numerals designate the same or similar parts. Furthermore, when the terms “first”, “second”, “inner”, “outer” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

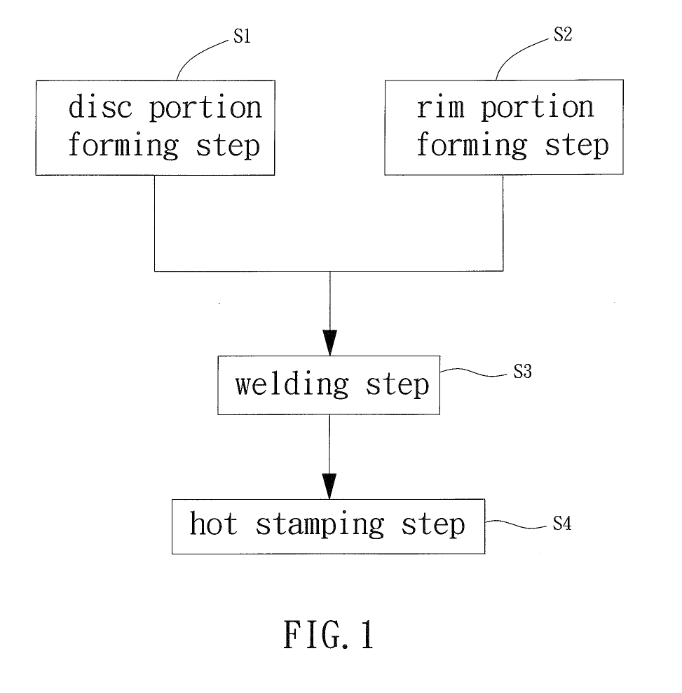

FIG. 1 shows a method for manufacturing a rim according to a preferred embodiment of the invention. The method includes a disc portion forming step S1, a rim portion forming step S2, a welding step S3 and a hot stamping step S4.

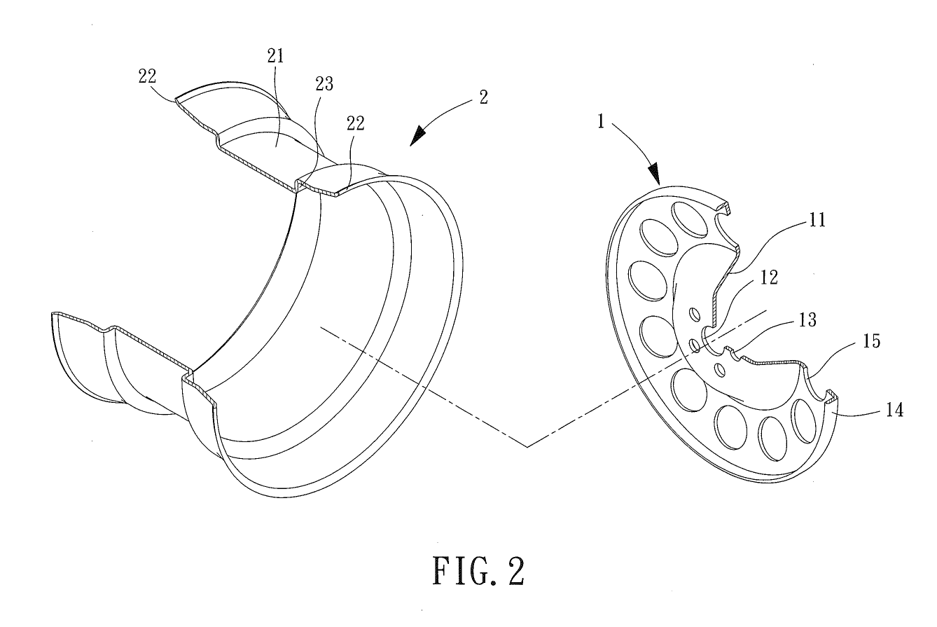

Referring to FIGS. 1 and 2, the disc portion forming step S1 is configured to process a first material with cold stamping process to form a disc embryo 1. The first material is a disc embryo which is carbon steel having a carbon content of 0.08-2%. Alternatively, the first material is alloy steel. Based on this, the first material can have a rust resistance or acid resistance and can be high-strength alloy steel to possess excellent rigidity. The invention is not limited to any option. The disc embryo 1 includes a body 11 having a through-hole 12 at a center thereof, a plurality of screw holes 13 surrounding the body 11, and a coupling portion 14 on an outer periphery thereof. In the cold stamping process of the invention, the first material is sent to the stamping machine to undergo the processes such as cutting, bending, stretching, etc. Since it is not required to cope with the rebounding of the metal, the disc embryo 1 can be obtained in 5-7 rounds of processing. The disc embryo 1 needs to undergo a certain number of rounds of the processing until the through-hole 12 and the screw holes 13 are formed and the coupling portion 14 is completely shaped.

Besides, the disc portion forming step S1 is also configured to form a plurality of decorative holes 15 on the disc embryo 1. The decorative holes 15 are located between the screw holes 13 and the coupling portion 14 and are not limited to any shape. For example, each decorative hole 15 is in a circular, triangular or trapezoid shape. The decorative holes 15 are preferably arranged in pairs. Thus, the decorative holes 15 can enhance the circulation of the air while providing an aesthetic effect.

The rim portion forming step S2 is configured to process a second material with cold rolling process to form a rim embryo 2. The second material is a steel coil which is carbon steel having a carbon content of 0.08-2%. Alternatively, the second material is alloy steel. Based on this, the second material can have rust resistance or acid resistance and can be high-strength alloy steel to possess excellent rigidity. The invention is not limited to any option. Then, the second material undergoes some processes to form a narrow, thin steel plate, such as, but is not limited to, cutting, flattening, etc. In the cold rolling process of the rim embryo 2, the second material is sent to a rolling mill to undergo a rolling process, a bending process, etc. Thus, the second material can be rolled into a circular form. The head and terminal ends of the rolled second material are welded together to form an enclosed structure, which then undergoes a plurality of rounds of precise-shaping processes to form the rim embryo 2. The rim embryo 2 includes a peripheral body 21. A protruding part 22 is formed at each of two ends of the peripheral body 21. An engagement portion 23 is formed on an inner periphery of the rim embryo 2. Since it is not required to cope with the metal rebounding that occurs in the case of cold rolling process, the rim embryo 2 can be formed after 4-6 rounds of rolling and bending processes. The rim embryo 2 needs to undergo a certain number of rounds of the processing until a rim is substantially shaped in a manner that the engagement portion 23 of the rim embryo 2 can match the coupling portion 14 of the disc embryo 1.

The welding step S3 is configured to couple the coupling portion 14 of the disc embryo 1 and the engagement portion 23 of the rim embryo 2 with each other by welding, so as to form a rim. In this embodiment, gas-shielded arc welding is used to couple the coupling portion 14 and the engagement portion 23 by fusion bonding. The operation of the gas-shielded arc welding is not limited to the space and is convenient. Also, the gas-shielded arc welding can smelt the welded parts into a fused state and therefore forms a secure welded structure after welding. The disc embryo 1 and the rim embryo 2 form a semi-processed rim after welding. A welded part W of the coupling portion 14 and the engagement portion 23 is welded by full welding to provide a more secure welding quality.

The hot stamping step S4 is configured to process the semi-processed rim with hot stamping process to produce a rim as a finished product. In the hot stamping process, the semi-processed rim is sent to a heating furnace having a temperature of 1050-1280° C. to soften the steel material. Then, the softened steel material is sent to a hot stamping machine to undergo the stamping processes, precisely shaping the semi-processed rim into a desired shape or further adjusting the thickness of the semi-processed rim to a meet the requirement. Thus, a rim is formed as a finished product. In addition, the rim as a finished product can be cooled down by a cooling system in a quenching process, thus obtaining a Martensite crystal structure. Accordingly, the welded part W can also be re-heated and quenched so that the heat affected zones are not annealed, forming a high-strength rim.

In summary, in the method for manufacturing a lightweight and high-strength rim according to the invention, the steel material will have a higher strength after the hot stamping process. In the same time, the heat affected zones are heated and quenched. Thus, the heat affected zones are not annealed, and the strength after the hot stamping processes is not adversely affected by the softening of the heat affected zones. Therefore, under the same weight, the rim according to the invention has a higher strength compared with the other rims. On the contrary, under the same strength, the rim according to the invention can have a smaller thickness compared with the other rims. As a result, the weight of the rim can be reduced, reducing the fuel consumption.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A method for manufacturing a rim, comprising:
processing a first material with a cold stamping process to form a disc embryo, wherein the first material is made of steel;
processing a second material with a cold rolling process to form a rim embryo, wherein the second material is made of steel;
coupling the disc embryo and the rim embryo with each other by a welding approach to form a semi-processed rim; and
processing the semi-processed rim with a hot stamping process to form the rim.

2. The method for manufacturing the rim as claimed in claim 1, wherein processing the semi-processed rim includes sending the semi-processed rim to a heating furnace having a temperature of 1050-1280° C. for heating and stamping operations.

3. The method for manufacturing the rim as claimed in claim 1, wherein the first and second materials are high-strength alloy steel.

4. The method for manufacturing the rim as claimed in claim 1, wherein processing the first material with the cold stamping process includes performing 5-7 rounds of the cold stamping process on the first material to form the disc embryo.

5. The method for manufacturing the rim as claimed in claim 1, wherein processing the second material with the cold rolling process includes performing 4-6 rounds of cold rolling process on the second material to form the rim embryo.

6. The method for manufacturing the rim as claimed in claim 1, wherein the welding approach is gas-shielded arc welding.

7. The method for manufacturing the rim as claimed in claim 1, wherein the welding approach is full welding.

8. The method for manufacturing the rim as claimed in claim 1, wherein processing the semi-processed rim includes a quenching process.

9. The method for manufacturing the rim as claimed in claim 1, wherein processing the first material includes forming a plurality of decorative holes on the disc embryo.
